(19) United States
(12) Patent Application Publication
(10) Pub. No.: US 2015/0264000 A1
(43) Pub. Date: Sep. 17, 2015

(54) METHOD AND SYSTEM FOR HANDLING AN ELECTRONIC MESSAGE

(71) Applicant: UNIFIED INBOX PTE LTD., Singapore City (SG)

(72) Inventor: TOBIAS RUECKERT, WINTERBACH (DE)

(73) Assignee: UNIFIED INBOX PTE LTD., Singapore City (SG)

(21) Appl. No.: 14/641,361

(22) Filed: Mar. 7, 2015

(30) Foreign Application Priority Data
Mar. 16, 2014 (DE) 10 2014 003 520.4

(51) Int. Cl. H04L 12/58

(52) U.S. Cl. CPC H04L 51/12; H04L 51/22

(57) ABSTRACT

A method and a system for handling an electronic message from a sender to a recipient. With the method according to the invention, when the electronic message has been transmitted to a message management system of the recipient, it is examined whether the electronic message shall be delivered to the recipient. The said examination is made by a filter as a function of the sender and/or a content of the electronic message. According to the invention, at least two different filters are provided, of which at least one filter is active, i.e., is being used.

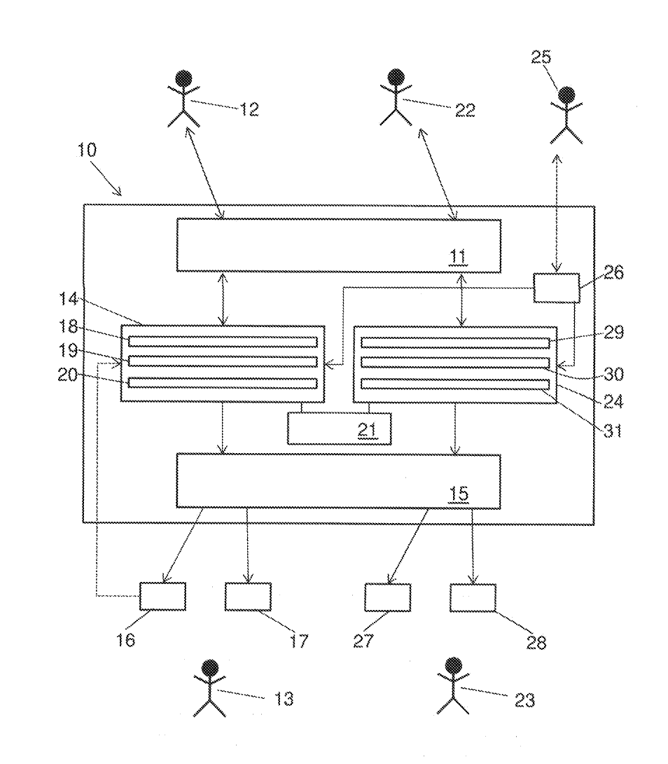

### CROSS-REFERENCE TO RELATED APPLICATION

This application claims the priority of German Application No. 10 2014 003 520.4 filed Mar. 16, 2014, which is incorporated herein by reference in its entirety as though fully set forth.

### BACKGROUND OF THE INVENTION

The invention relates to a method for handling an electronic message from a sender to a recipient with the objects of the generic concept of claim 1 and a system for handling an electronic message from a sender to a recipient with the objects of the generic concept of claim 9.

The number of electronic messages, for example, as e-mails, short messages such as SMS (short message service) messages or messages in a social network, is increasing constantly. In addition, the electronic messages from the sender can be received on different output devices such as, for example, a conventional computer, a tablet computer, a mobile phone or an intelligent watch enabling the recipient to read electronic messages virtually at any time. Due to the frequently practiced international cooperation across many time zones and cultural areas there are virtually no defined time spaces left in which no electronic messages are sent to a recipient. This makes it increasingly difficult to find phases for switching off and relaxing. Besides, it is also not possible for everyone simply to ignore all electronic messages for a certain time, for example, at a weekend. Therefore, a possibility should be created for the recipient of electronic messages to determine in a simple manner which electronic messages are really of relevance to him or her and should therefore be delivered directly and which are not so relevant and therefore can be handled at a later time or can be ignored. This should be possible particularly independent of the type of the electronic message.

In U.S. Pat. No. 8,073,918 B2, a method and a system for handling an electronic message from a sender to a recipient are disclosed. The electronic message in that case is an e-mail message with a subject and a message content. With that method, an examination is made to see whether the electronic message shall really be delivered to the recipient. On a first examination level it is checked whether a sequence of words defined by the recipient of the message is contained in the subject of the electronic message. If it is, the electronic message is delivered directly to the recipient. If the sequence of words is not contained, the message is examined again on a second examination level. Depending on the result of the examination on the second examination level, the electronic message is either delivered directly, provided for verification by the recipient, or deleted. The combination of first and second levels of examination is considered as filter in that case.

In contrast with that, it is the object of the invention to contemplate a method and a system by which it can be decided in a simple way what electronic messages are delivered to a recipient. According to the invention, this object is accomplished by a method with the objects of claim 1 and a system with the objects of claim 9.

### SUMMARY OF THE INVENTION

In accordance with the invention, with the method for handling an electronic message from a sender to a recipient, the electronic message when it has been transmitted to a message management system of the recipient is examined to see whether the electronic message is to be delivered to the recipient. The said examination is made by a filter as a function of the sender and/or a content of the electronic message. In accordance with the invention, at least two different filters are provided for the said examination, of which one filter is active, i.e., it is being used. In this way it can be set, by a simple change of the filters, which electronic messages shall be delivered to the recipient and in this way the delivery of the electronic messages can be adapted to the respective situation of the recipient.

The delivery of an electronic message to the recipient, as used here, shall mean that the electronic message is sent to an output device of the recipient such as, for example, a traditional computer, a tablet computer, a mobile phone or an intelligent watch or is retrievable via the output device. The said message management system receives the electronic message via an input module, which may have different interface modules, and then performs the said examinations. The different output devices are, particularly, linked to the message management system via a network link, for example, via the internet.

During the examination whether the electronic message shall be delivered to the recipient it is examined particularly whether the sender of the electronic message is a permitted, a blocked or an unknown sender. For this purpose, in particular, different lists with senders are stored in the message management system. Also used for that purpose can, for example, be available lists such as, for example, an address book, mailing lists, chat groups, forum membership lists or lists of friends in social networks. It is also possible to see whether the sender is linked with another, permitted, sender. The link can, for example, be established in that the sender is listed in a so called list of friends of the permitted sender. In addition to that, the content of the electronic message, which can be composed of a subject and a message text, is examined to see whether it contains certain words or word sequences. In the professional sphere, these words or word sequences can relate to certain projects, tasks or jobs and in the private sphere, for example, to certain leisure time activities. It is also possible to examine whether the content of the electronic message contains a link to current tasks or calendar entries of the recipient. The link can, for example, be that identical or similar terms are contained. For the definition of a filter of the message management system the results of the different scans can be combined with each other in any way, i.e., linked by logical “and”, “or” and “and not”. A first filter can, for example, be defined such that only messages are delivered that were sent by an approved sender and contain a word, for example, a project name. A second filter can, for example, be defined such that an electronic message is delivered when the sender is not an approved sender and, in addition, does not contain a certain sequence of words. A filter can, for example, also be defined such that it delivers all messages.

The said filters can, in addition, consider the day of the week and/or the time of day at the abode of the recipient or in a defined time zone. It is also possible that the filter checks whether the electronic message is addressed to several recipients and/or whether a recipient is not addressed directly but only receives a copy of the electronic message.

Thus, filters may be defined that can very exactly be adapted to the needs of the recipients. By providing at least two filters, of which one filter can be enabled very easily, the filter fitting the present life situation of the recipient can be used very easily. The filters can, for example, also be named after the life situation for which they were designed. Thus, filters, for example, with the designations “Work”, “At home”, “On travel”, “Private event”, etc., can exist.

It is also possible that not only one but several filters are active at the same time, which are worked through one after the other. It can be defined, in addition, whether an electronic message will only be delivered when the examination produces a positive result with all filters or whether the positive result of the examination of one or a defined number of filters is sufficient.

The electronic message can, for example, be designed as an e-mail, an SMS (short message service) message, a message in a social network such as, for example, Facebook®, LinkedIn®, a message in a short message service such as, for example, Twitter® or in a so called instant messaging system such as, for example, Skype®. The electronic message can, for example, also be designed as an entry in a freely accessible on-line forum or in an on-line forum with restricted access, for example, in a corporate network. It is also possible that an electronic message is obtained by conversion from a paper letter. Hence, the type of the electronic message and therefore also a communication channel used does fundamentally not play a role for the application of the method according to the invention.

In embodying the invention, the active filter can be selected by the recipient and by an administrator of the message management system. This provides a particularly large flexibility. For example, the recipient himself or herself can decide which electronic messages he or she wants to receive at a time. Besides, the said administrator of the message management system who, for example acts on behalf of the recipient's employer, can set the response of the message management system. In this way, for example, certain corporate directives for the protection of the recipient such as, for example, no delivery of business electronic messages at weekends, can be implemented. On the other hand, it can also be ensured in this way that, irrespective of the settings by the recipient, extremely important business electronic messages are delivered to the recipient in any case.

In embodying the invention, the said filters can be adapted by the recipient and/or the administrator. This allows the recipient to adapt predefined filters to his or her own needs. For this, in particular, a graphic user interface can be provided to him or her, in which the filters can be changed in a particularly simple manner. It is also possible that the message management system is designed such that it adapts the filters automatically to the recipient as a function of the recipient's response. The message management system can, for example, keep a watch on calendar entries of the recipient and the tasks assigned to it, for example, in a project management system. In addition, the message management system can learn from the recipient's communication behavior at the times during which the recipient is in a conference or works at a certain task, viz., for example, how often he or she checks his or her inbox, browses through or receives new electronic messages and also how many and through what communication channels he or she submits electronic messages at that time. On the request of the recipient, an automatic localization function can also be integrated in the message management system. This enables the message management system proactively to suggest a suitable filter, for example, with the designation “At home” or “Office” relating to the whereabouts of the recipient and also set or reposition it automatically if requested.

In embodying the invention, the message management system transmits to the sender a feedback message on the result of the examination of whether the electronic message will or will not be delivered to the recipient. In this way, the sender can be given a feedback as to the way in which his or her electronic message has been handled, that is, whether, for example, it has not been delivered and he or she therefore cannot expect a reply from the recipient.

In the said feedback message to the sender, the latter can, for example, in addition, can be informed about a whereabouts of the recipient, a “status” (for example, “busy for the whole day”, “be back in a minute”) or a “mood” (for example, “cheerful”, “sad”, “tired”). Whether and, where applicable, what feedback message will be sent to the sender can also be set by the recipient, for example, as a function of the sender and/or the content of the electronic message to the recipient.

In embodying the invention, it can be set that the electronic message is delivered to the recipient only after it has been confirmed by the sender. So in that case the sender will at first be sent a feedback message that the recipient actually does not want to receive any or at least not that electronic message. If the sender insists on delivery, he or she can send this information to the message management system of the recipient and as a consequence of it the electronic message will be delivered to the recipient. In this way, the sender is requested to reconsider the relevance of the electronic message before it is delivered to the recipient and the latter is disturbed. This ensures that only really relevant messages are delivered to the recipient.

In embodying the invention, several recipients share the said management system. In that case, the said filters can be exchanged among the different recipients. Thus, filters that have performed well with one recipient can also be used by other recipients without the latter having to define the filter again. This makes handling the filters particularly easy.

In embodying the invention, the electronic message can, as described above, be delivered to different output devices. The output devices to which the message shall be delivered can be defined in the said filters. For example, it can be set that the electronic message is delivered only to a computer in office of the recipient. This can be done, for example, when it is clear that the message can only be processed reasonably in the office. On the other hand, it can be set that an electronic message is delivered to all available output devices and therefore all communication channels available for the delivery of electronic messages are used. This will be done particularly when an electronic message is considered to be particularly important and as such should reach the recipient under all circumstances. In this way, the message management systems can be adapted to the needs of the recipient especially well.

In embodying the invention, the way in which an electronic message not delivered to the recipient should be handled can be defined. For example, it can be set that an undelivered message is logged until a filter is selected that permits the message to be delivered. In addition, in particular, a maximum time can be set for which an electronic message will be logged waiting for delivery to the recipient. It is also possible to delete undelivered messages immediately. The sender can be informed of the way in which the electronic message is handled as described above. The way in which undelivered electronic messages are handled can particularly be defined directly in the said filters. It is not necessary that all electronic messages are handled in the same way; on the contrary, differences can be made. But it is also possible that only the undelivered electronic messages are processed in a module downstream the said filters and that module decides how the undelivered message should be handled. For that, scans similar to those in the filters disclosed can be used.

The said object of the invention is also disclosed by a system for processing an electronic message from a sender to a recipient which has a message management system with an examination system. The purpose of the examination system is, after transmitting the electronic message to the message management system, to check whether the electronic message should be delivered to the recipient and to make the examination by means of a filter as a function of the sender and/or a content of the electronic message. To the accomplishment of the foregoing, the invention contemplates that the examination system has at least two different filters, one of which is active.

### BRIEF DESCRIPTION OF THE DRAWINGS

Other embodiments of the invention will become apparent from the description and the drawing. Illustrative embodiments of the invention are set forth in simplified manner in the drawing and explained in detail in the following description in which:

The sole FIGURE is a schematic diagram of a system for handling electronic messages from a sender to a recipient.

### DETAILED DESCRIPTION OF THE INVENTION

With reference to the sole FIGURE, a system for handling electronic messages comprises a message management system 10 with an input module 11 by which electronic messages from different senders, for example, from a first sender 12 can be received. The electronic message can, for example, be designed as an e-mail, an SMS (short message service) message or as any other type of electronic message. The input module 11 comprises several interface modules not illustrated, by which the messages can be received via the internet. After receiving the electronic message, the input module 11 examines for what recipient the electronic message is intended. In the example described here, the electronic message is intended for a first recipient 13. For that reason, the electronic message is sent to a first examination system 14 that is assigned to the first recipient 13. This examination system 14 examines how the received first message should be handled. More exactly, the examination system 14 examines whether the electronic message should be delivered to the first recipient 13 via an output module 15. The delivery of the electronic message can be to one of several, here two different output modules 16, 17 which can, for example, be a conventional computer, a tablet computer, a mobile phone or an intelligent watch. In delivering the electronic message, the output module can send the electronic message actively to the output devices 16, 17 or provide them in such a way that they can be called by the output devices 16, 17.

In order to decide whether the received electronic message is delivered to the first recipient 13 as described, different filters 18, 19, 20 are defined in the first examination system, of which at least one is active.

The said first examination is made, in the first place, as a function of the sender and a content of the electronic message. For that, in the filters 18, 19, 20, it is defined electronic messages from what senders are delivered and from what senders they are not delivered. In addition, words and word sequences are defined that when they are encountered cause the electronic message to be delivered or not. If an electronic message, such as, for example, an e-mail, contains a subject and a message text, it can be defined, in addition, whether the said words or word sequences must or should not be contained in the subject or in the message text. The different conditions can be combined logically in any way so that a filter 18, 19, 20 may comprise of several scans performed one after the other.

For example, it can be defined in a filter that electronic messages that
originate from a sender A,
originate from a sender B and contain the word X in the subject,
the word sequence Y in the subject or in the message text are delivered, and electronic messages that
originate from a sender C,
contain the word sequence Z in the subject are not delivered.

In the examination of an electronic message in examination system 14 every scan of an active filter is performed and the electronic message processed further depending on the result of the scans.

The recipient 13 can view the different filters 18, 19, 20 on his or her output devices 16, 17 and enable one of the filters 18, 19, 20 so that that filter is applied. One of the filters 18, 19, 20 is defined such that all electronic messages are delivered to the recipient 13.

Besides, the recipient 13 can change the filters 18, 19, 20 and adapt them to his or her needs. For that, he or she can either edit the filters 18, 19, 20 as text file. But it is also possible that he or she is provided with a graphic user interface through which he or she can insert or remove senders or words or word sequences.

In addition, conditions relating to the day of the week, the time of the day or the time zone in which the recipient 13 is staying can be contained in the filters.

It can also be defined in the filters 18, 19, 20 what is going to happen to an electronic message that is not delivered directly. It can be defined whether it is deleted or placed in a buffer memory 21. Electronic messages which are placed in the buffer memory 21 are scanned regularly by the filters enabled at the time to see whether they are yet to be delivered. A maximum storage period is defined after which the electronic messages are removed from the buffer storage and deleted. That maximum storage period can be the same for all electronic messages or it can vary.

The recipient 13 can also define in the filters whether the message management system 10 sends a feedback message about the result of the said examination to the sender of the electronic message via the input module 11. The feedback message to the sender can, for example, be that the electronic message has not been delivered to the recipient or that it has been placed in the buffer memory. Alternatively or additionally, the sender can also be sent another message.

It can also be defined in the filters that when an electronic message with special features, particularly as to sender, content, day of the week, and time, is received, the message management system 10 sends a feedback message to the sender that the recipient actually would not like to receive messages at present but the delivery will still be made on the request of/confirmation by the sender. If the sender confirms the delivery to the recipient by a confirmation message to the message management system 10, the electronic message will be delivered to the recipient.

It can also be defined in the filters that electronic messages with particular features are delivered only to specific output devices, for example, only to the output device 16 but not to the output device 17.

The message management system not only processes electronic messages from a first sender 12 to a first recipient 13 but also electronic messages from a second sender 22 to a second recipient 23. To this end, the message management system 10 comprises a second examination system 24 the design of which is generally identical to that of the first examination system 14 where filters 29, 30, 31 are equivalent to described filters 18, 19, 20 of the first examination system 24 and output modules 27, 28 are equivalent to described output modules 16, 17. The recipients 13 and 23 can exchange filters of their respective examination system.

In addition to the recipients 13 and 23 of the electronic messages an administrator 25 can also access the message management system 10. Thus, the administrator 25 can also access the two examination systems 14 and 24 and enable or adapt a particular filter or provide new filters. In this way, for example, corporate directives for handling electronic messages can be implemented. The administrator 25 can also access the two examination systems 14 and 24 via an interface module 26.

The message management system can comprise further modules and functions which are not of particular interest here and which, for that reason, have not been disclosed and described in detail here.

What is claimed is:

1. Method for handling an electronic message from a sender to a recipient, said method comprising the following steps:
transmitting the electronic message to a message management system of the recipient, and
examining whether the electronic message should be delivered to the recipient by a filter as a function of the sender and/or a content of the electronic message, wherein for the said examination providing at least two different filters of which at least one filter is active.

2. Method according to claim 1, further comprising the step of selecting the at least one active filter by the recipient and/or by an administrator of the message management systems.

3. Method according to claim 1, further comprising the step of adapting the said filters by the recipient and/or an administrator.

4. Method according to claim 1, further comprising the step of transmitting by the message management system to the sender a return message on the result of the said examination.

5. Method according to claim 4, further comprising the step of setting the electronic message to only be delivered to the recipient after a confirmation from the sender.

6. Method according to claim 1, further comprising the step of several recipients sharing the use of the said message management system and the said filters being exchanged between the several recipients.

7. Method according to claim 1, further comprising the step of delivering the electronic message to different output devices and defining in the said filters to which output devices the electronic message shall be delivered.

8. Method according to claim 1, further comprising the step of defining how an electronic message not delivered to the recipient shall be handled.

9. System for handling an electronic message from a sender to a recipient including a message management system comprising an examination system for examining the electronic message after the latter has been transmitted to the message management system for determining whether the electronic message shall be delivered to the recipient and for performing the said examination by means of a filter as a function of the sender and/or a content of the electronic message, wherein the examination system comprises at least two different filters of which at least one filter is active.
